(19) United States
(12) Patent Application Publication
(10) Pub. No.: US 2026/0066287 A1
(43) Pub. Date: Mar. 5, 2026

(54) SOLID ELECTROLYTE-ELECTRODE ASSEMBLY, METHODS FOR MAKING, AND AN ALL-SOLID-STATE BATTERY THEREOF

(71) Applicants: LG ENERGY SOLUTION, LTD., Seoul (KR); The Regents of the University of California, Oakland, CA (US)

(72) Inventors: Jung-Pil LEE, Daejeon (KR); Jiyoung KIM, Daejeon (KR); Dong Ju LEE, La Jolla, CA (US); Zheng CHEN, San Diego, CA (US); Min-Sang SONG, Daejeon (KR)

(73) Assignees: LG ENERGY SOLUTION, LTD., Seoul (KR); The Regents of the University of California, Oakland, CA (US)

(21) Appl. No.: 18/821,654

(22) Filed: Aug. 30, 2024

(51) Int. Cl. H01M 4/525; H01M 4/02; H01M 4/04; H01M 4/505; H01M 10/0562

(52) U.S. Cl. CPC H01M 4/525; H01M 4/0435; H01M 4/505; H01M 10/0562; H01M 2004/021; H01M 2004/028

(57) ABSTRACT

A solid electrolyte-electrode assembly, as well as an all-solid-state battery including the assembly are described. For instance, a solid electrolyte-cathode assembly can be formed by co-rolling a plurality of cathode particles and a plurality of solid electrolyte particles, which results in the simultaneous production of the assembly and makes it possible to achieve improved interface resistance between the electrolyte membrane and electrode to improve battery performance. Also, the resulting electrolyte can be thin, which improves the energy density, while also maintaining excellent strength by using an electrode as a support.

### FIELD OF TECHNOLOGY

The present disclosure relates to a solid electrolyte-electrode assembly, as well as a solid state battery thereof. The solid electrolyte-cathode assembly can be formed by co-rolling a plurality of cathode particles and a plurality of solid electrolyte particles, which results in the simultaneous production of the solid electrolyte-electrode assembly.

### BACKGROUND

There continues to be an increase in electrified transportation, exemplified by the widespread adoption of electric vehicles (EVs) and the emergence of urban air mobility (UAM) vehicles. Simultaneously, there is a growing demand for stationary energy storage systems, notably in the residential and industrial sectors, powered by solar and wind generators. This shift is driven in part by the pressing need to mitigate the adverse environmental and climate impacts associated with traditional internal combustion engines and other non-renewable means of power generation. Thus, the development of battery technologies with high energy density, while also ensuring enhanced safety, has become an imperative.

Conventional liquid lithium-ion batteries were critical to the advancement of electrified transportation and energy storage systems, and have had a significant and positive impact on green energy and climate change mitigation efforts. While such conventional liquid lithium-ion batteries are superior to many other energy sources, liquid lithium-ion batteries also have certain limitations. For example, various safety mechanisms are critical for lithium-ion batteries to restrict voltage and internal pressures, but these safety features typically result in increased weight and performance limitations in certain instances. Moreover, lithium-ion batteries are susceptible to aging, leading to capacity loss and eventually failure after a number of years of use.

In an all-solid-state battery (ASSB), a solid electrolyte is used instead of a liquid electrolyte, making the entire battery solid. The solid electrolyte is intrinsically non-flammable and can accommodate a wider temperature range, allowing it to function as electrochemical energy storage without the need for additional safety devices. Solid state batteries, which offer higher energy density, are safer than batteries with a liquid electrolyte system, such as conventional lithium-ion batteries. In a conventional solid state battery, a solid electrolyte replaces a liquid electrolyte system, and thus reduces the risk of ignition or explosion, thereby increasing safety.

For example, lithium-sulfur batteries using lithium and an alkali metal as an anode active material and sulfur as a cathode active material have a theoretical energy density of 2,800 Wh/kg (1,675 mAh), which is significantly higher than those of other battery systems, and have received attention as portable electronic devices due to an advantage in that sulfur is inexpensive due to the abundance in resources, and an environmentally-friendly material. Lithium metal is advantageous because it is lightweight and has high energy density, and various cathode active materials may be used for lithium batteries, including sulfur-containing cathode active materials having sulfur-sulfur bonds, which have high energy capacities. However, when sulfur is used as a cathode active material for a lithium-sulfur battery, it is a non-conductor, making it difficult for electrons produced by an electrochemical reaction to move. Also, in the case of sulfur anode, due to the large volume change during charging and discharging, there is an issue with reduced performance and lifetime.

Therefore, there is a high need for a technology to increase energy density, improve cycle characteristics and lifetime in an ASSB technology.

### SUMMARY

The present disclosure relates to a solid electrolyte-cathode assembly for use in an ASSB technology. The solid electrolyte-cathode assembly can be formed by co-rolling a plurality of cathode particles and a plurality of solid electrolyte particles, which results in the simultaneous production of the assembly. It is possible to achieve improved interface resistance between the electrolyte membrane and electrode, which improves battery performance. Also, the electrolyte can be much thinner, which improves the energy density, while also maintaining excellent strength.

A method for manufacturing a solid electrolyte-cathode assembly is described, which comprises: providing a plurality of cathode particles; providing a solid electrolyte, wherein the solid electrolyte is provided in the form of particles having an average particle size less than 5 μm; providing a binder; and co-rolling the plurality of cathode particles, the solid electrolyte, and the binder, under conditions to form the solid electrolyte-cathode assembly. In some aspects, the solid electrolyte-cathode assembly may comprise a cathode layer having a thickness less than 50 μm and a solid electrolyte layer having a thickness less than 50 μm, such that the cathode layer structurally supports the solid electrolyte layer. In some aspects, an amount of binder is less than 1%, such that contact between the cathode layer and the solid electrolyte layer is increased. In some aspects, a ratio of a thickness of the cathode layer to a thickness of the solid electrolyte layer is from 1:1 to 1:5 such that an interface resistance between the cathode layer and the solid electrolyte layer is reduced.

A method for manufacturing a solid electrolyte-cathode assembly is described, which comprises: providing a plurality of cathode particles, wherein the cathode particles comprise a lithium nickel manganese cobalt oxide; providing a solid electrolyte, wherein the solid electrolyte is provided in the form of particles having an average particle size less than 5 μm; providing a binder; and co-rolling the plurality of cathode particles, the solid electrolyte, and the binder, under conditions to form the solid electrolyte-cathode assembly. In some aspects, the solid electrolyte-cathode assembly can comprise a cathode layer having a thickness of more than 10 μm and less than 50 μm and a solid electrolyte layer having a thickness of more than 10 μm and less than 50 μm, such that the cathode layer structurally supports the solid electrolyte layer; the amount of binder is less than 1%, such that contact between the cathode layer and the solid electrolyte layer is increased; and a ratio of a thickness of the cathode layer to a thickness of the solid electrolyte layer is from 1:1 to 1:5 such that an interface resistance between the cathode layer and the solid electrolyte layer is increased.

A solid electrolyte-cathode assembly is described, which can be prepared by: providing a plurality of cathode particles; providing a solid electrolyte, wherein the solid electrolyte is provided in the form of particles having an average particle size less than 5 μm; providing a binder; and co-rolling the plurality of cathode particles, the solid electrolyte, and the binder, under conditions to form the solid electrolyte-cathode assembly. In some aspects, the solid electrolyte-cathode assembly comprises a cathode layer having a thickness of more than 10 μm and less than 50 μm and a solid electrolyte layer having a thickness of more than 10 μm and less than 50 μm, such that the cathode layer structurally supports the solid electrolyte layer; the amount of binder is less than 1%, such that contact between the cathode layer and the solid electrolyte layer is increased; and a ratio of a thickness of the cathode layer to a thickness of the solid electrolyte layer is from 1:1 to 1:5 such that an interface resistance between the cathode layer and the solid electrolyte layer is increased.

An all-solid-state battery is described, which comprises the solid electrolyte-cathode assembly described herein.

In some aspects, the solid electrolyte-cathode assembly does not have a current collector. For instance, a cathode current collector such as aluminum (Al) is not needed.

In some aspects, the solid electrolyte-cathode assembly has a porosity great than about 10%

In some aspects, an amount of binder is less than 0.5%, less than 0.1%, less than 0.05%, and greater than 0%, greater than 0.01%, greater than 0.05%, or greater than 0.1%. In some embodiments, only a very small amount of binder needed, because there is a supporting cathode layer in the resulting solid electrolyte-cathode assembly. In some aspects, the amount of binder may be more than 0%, more than 0.05%, or more than 0.1%.

In some aspects, the cathode particles have an average particle size of 0.1 un to 20 [symbol] ; 0.1 [symbol] to 10 [symbol] ; 1 [symbol] to 5 [symbol] ; or 1 [symbol] to less than 5 [symbol] . For example, the cathode particles can be in the sub-micron to micron range.

In some aspects, the cathode layer has a thickness of greater than or equal to 25 μm, a thickness of greater than or equal to 15 μm, a thickness of greater than or equal to 10 μm, a thickness of greater than or equal to 7 μm or a thickness of greater than or equal to 5 μm. In some aspects, the cathode layer has a thickness less than 100 μm, less than 90 μm, less than 80 μm, less than 70 μm, less than 60 μm, or less than 50 μm.

In some aspects, in the solid electrolyte-cathode assembly, the solid electrolyte layer has a thickness less than 50 μm, less than 40 μm, less than 30 μm or less than 20 μm.

Some aspects relate to where the ratio of a thickness for the cathode layer to a thickness of the solid electrolyte layer (in the solid electrolyte-cathode assembly) is from about 1:1 to 1:5, from about 1:1 to 1:4, from about 1:1 to 1:3, from about 1:1 to 1:2, or about 1:1. The ratio of the cathode particles to the solid electrolyte particles may be controlled to improve the layer uniformity and/or surface quality of the resulting solid electrolyte-cathode assembly.

In some aspects, in the solid electrolyte-cathode assembly, a weight ratio of the cathode particles to the solid electrolyte is from 1:1 to 1:5. In some aspects, a weight ratio of the cathode particles to the solid electrolyte is about 1:2.

In some aspects, the method for making the solid electrolyte-cathode assembly is carried out under dry processing conditions.

In some aspects, the method for making the solid electrolyte-cathode assembly includes co-rolling at a temperature of from about room temperature to about 120° C.

### BRIEF DESCRIPTION OF THE DRAWINGS

The accompanying drawings illustrate aspects of the present disclosure, and together with the detailed disclosure, serve to provide a further understanding of the technical aspects of the present disclosure, and the present disclosure should not be construed as being limiting to the drawings. In the drawings, for clarity of description, the shape, size, scale or proportion of the elements may be exaggerated for emphasis.

FIG. 1A shows a Comparative Example formed according to a conventional method where there is a problem of mechanical failure when using a thin solid state electrolyte (SSE) to form an assembly due to poor mechanical property of the film.

FIG. 1B shows an Example according to disclosed aspects where the solid electrolyte-electrode assembly is formed by co-rolling a plurality of cathode particles and a plurality of solid electrolyte particles, which results in the simultaneous production of the assembly and mitigates mechanical failure of the thin SSE layer.

FIGS. 2A and 2B illustrate solid electrolyte-cathode assemblies formed according to an Example according to disclosed aspects (FIG. 2A) and a Comparative Example (FIG. 2B).

FIG. 3 illustrates the mechanical strengths of solid electrolyte-cathode assemblies formed according to an Example according to disclosed aspects and Comparative Examples.

FIGS. 4A, 4B, 4C, and 4D illustrate the electrochemical characterizations of solid electrolyte-cathode assemblies formed according to an Example according to disclosed aspects and a Comparative Example, including schematic illustrations of the Example (FIGS. 4A and 4B), a schematic illustration of the Comparative Example (FIG. 4B), lithium ion transport characteristics in the solid electrolyte for the Example and Comparative Example (FIG. 4C), and lithium ion transport characteristics in the cathode for the Example and Comparative Example (FIG. 4D).

### DETAILED DESCRIPTION

Hereinafter, the present disclosure will be described in detail. It should be understood that the terms or words used in the specification and the appended claims should not be construed as limited to general and dictionary meanings, but rather interpreted based on the meanings and concepts corresponding to the technical aspects of the present disclosure on the basis of the principle that the inventor is allowed to define terms appropriately for the best explanation. Therefore, the aspects of the disclosure described herein and the elements shown in the drawings are just aspects of the present disclosure, but not intended to fully describe the technical aspects of the present disclosure, so it should be understood that other equivalents and modifications could have been made thereto at the time the application was filed. Unless defined otherwise, all the technical and scientific terms used herein have the same meanings as commonly known by a person skilled in the art. In the case that there is a plurality of definitions for the terms herein, the definitions provided herein will prevail.

Unless specified otherwise, all the percentages, portions and ratios in the present disclosure are on weight basis.

Unless indicated to the contrary, the numerical parameters set forth in the following specification and attached claims are approximations that may vary depending upon the desired properties sought to be obtained according to aspects of the disclosure. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values.

While compositions and methods are described herein in terms of “comprising” various components or steps, the compositions and methods can also “consist essentially of” or “consist of” the various components and steps. The term “comprise(s)” or “include(s)” when used in this specification, specifies the presence of stated elements, but does not preclude the presence or addition of one or more other elements, unless the context clearly indicates otherwise.

The terms “about” and “substantially” are used herein in the sense of at, or nearly at, when given the manufacturing and material tolerances inherent in the stated circumstances and are used to prevent the unscrupulous infringer from unfairly taking advantage of the present disclosure where exact or absolute figures are stated as an aid to understanding the present disclosure. The terms “about” and “approximate”, when used along with a numerical variable, generally means the value of the variable and all the values of the variable within an experimental error (e.g., 95% confidence interval for the mean) or within a specified value ±10% or within a broader range. Unless otherwise indicated, all numbers expressing quantities of ingredients, properties such as molecular weight, reaction conditions, and so forth used in the present specification and associated claims are to be understood may be modified by the term “about.”

“A and/or B” when used in this specification, specifies “either A or B or both.”

As used herein, the term “average particle size” means average obtained particle size as observed using scanning electron microscopy (SEM).

As used herein, the term “mean particle size” means mean particle size as observed using SEM.

### <All-Solid-State Battery>

An aspect of the present disclosure relates to a solid-state battery comprising a solid electrolyte material as an electrolyte. Specific examples of the solid-state battery include any type of primary battery, secondary battery, fuel cell, solar cell or capacitor such as a super capacitor. In particular, the battery is a lithium-ion secondary battery. Aspects of the disclosure here may be implemented in a secondary battery with various form factors or battery formats, including for example in a pouch-type battery, a cylindrical battery, or a prismatic battery.

The ASSB may be used in various applications, including small household power storage devices, motorcycles, electric vehicles, hybrid electric vehicles, cell phones, laptops, portable devices, etc.

### <Anode>

The term anode is used interchangeably with the term negative electrode.

The negative electrode current collector is not particularly limited as long as it is conductive without causing any chemical change in the all-solid-state battery, and for example, copper, stainless steel, aluminum, nickel, titanium, sintered carbon, copper or stainless steel whose surface is treated with carbon, nickel, titanium, silver or the like, or aluminum-cadmium alloy, etc. can be used. Additionally, as with the positive electrode current collector, the negative electrode current collector may include various forms such as a film, a sheet, a foil, a net, a porous body, a foam, and a nonwoven fabric having minute irregularities formed on their surfaces.

The anode comprises an anode material comprising a product of (i) a lithium (Li) powder, and (ii) a metal selected from aluminum (Al), tin (Sn) or mixture thereof, where the product is a prelithiated metal alloy having a chemical formula of LixMy, wherein Li is lithium, M is the metal, and x and y are integers greater than 0.

In certain aspects, a mass ratio of the lithium to the metal is from 1:4 to 1:20; and wherein the anode is free of a binder material. In some aspects, a mass ratio of the lithium to the metal is from 1:4 to 1:15, preferably the mass ratio of the lithium to the metal is from 1:4 to 1:10, preferably the mass ratio of the lithium to the metal is from 1:4 to 1:7.5, or preferably the mass ratio of the lithium to the metal is from 1:4 to 1:5.

In some aspects, the product is a prelithiated metal further comprising an additional metal selected from Al, Cu, Zn, Ga, In, Ag or mixtures thereof. For example, in some aspects, the additional metal is contained in an amount from 2.5 to 5% by weight.

Some aspects relate to where the product is a prelithiated metal having a chemical formula of Li_{0.25}Al, Li_{0.5}Al, or Li_{0.75}Al.

Some aspects relate to where the product is a prelithiated metal having a chemical formula of Li_{0.25}Sn, Li_{0.5}Sn, or Li_{0.75}Sn.

In some aspects, the lithium powder has an average particle size of 0.1 [symbol] to 50 [symbol] , preferably from 0.1 [symbol] to 50 [symbol] , preferably from 0.1 [symbol] to 50 [symbol] , 0.1 [symbol] to 50 [symbol] , or 0.5 [symbol] to 25 [symbol] .

In some aspects, an N/P ratio is from 1.00 to 2.00, preferably the N/P ratio is from 1.25 to 1.75, from 1.01 to 1.10, from 1.05 to 1.10 or 1.01 to 1.05.

The negative electrode active material may further comprise a lithium metal, a lithium alloy, a lithium metal composite oxide, a lithium-containing titanium composite oxide (LTO), and a combination thereof. In this case, the lithium alloy may be an alloy of lithium and at least one metal selected from Na, K, Rb, Cs, Fr, Be, Mg, Ca, Sr, Ba, Ra, Al and Sn. Also, the lithium metal composite oxide may be lithium and an oxide (MeO) of any one metal (Me) selected from the group consisting of Si, Sn, Zn, Mg, Cd, Cc, Ni and Fe and for example, may be LixFe₂O₃ (0≤x≤1) or LixWO₂ (0≤x≤1).

In addition, the negative electrode active material may comprise metal composite oxides such as SnₓMe₁₋ₓMe′_{y}O_{z} (Me: Mn, Fe, Pb, Ge: Me′: Al, B, P, Si, elements of groups 1, 2 and 3 of the periodic table, halogen; 0<x=1; 1=y=3; 1=z=8); oxides such as SnO, SnO₂, PbO, PbO₂, Pb₂O₃, Pb₃O, Sb₂O₃, Sb₂O₄, Sb₂O₅, GeO, GeO₂, Bi₂O₃, Bi₂O₄ and Bi₂O₅, and carbon-containing negative electrode active materials such as crystalline carbon, amorphous carbon or carbon composite may be used alone or in combination of two or more.

### <The Solid Electrolyte-Electrode Assembly>

In some aspects, the electrode is a cathode. The term cathode is used interchangeably with the term positive electrode.

In some aspects, a positive electrode current collector is not used. Alternatively, if a positive electrode current collector is used for the electrode, is not particularly restricted, as long as the positive electrode current collector exhibits high conductivity while the positive electrode current collector does not induce any chemical change in a battery to which the positive electrode current collector is applied. For example, the positive electrode current collector may be made of stainless steel, aluminum, nickel, titanium, or plastic carbon. Alternatively, the positive electrode current collector may be made of aluminum or stainless steel, the surface of which is treated with carbon, nickel, titanium, or silver.

The current collector is not limited to a particular type and may include those having high conductivity without causing a chemical change in the corresponding battery, for example, stainless steel, copper, aluminum, nickel, titanium, sintered carbon, or aluminum or stainless steel treated with carbon, nickel, titanium and silver on the surface.

The average particle size of the positive electrode active material is usually 0.1 μm to 50 μm, preferably 1 μm to 20 μm, or preferably 0.5 μm to 20 μm, from the viewpoint of improving battery characteristics such as load characteristics and cycle characteristics. The particle size can be adjusted to achieve a ASSB having a large charge/discharge capacity.

A positive electrode active material can include a positive electrode active material suitable for all-solid-state batteries, e.g., transition metal oxides, composite oxides of lithium and transition metals, transition metal sulfides, etc. In some aspects, Fe, Co, Ni, Mn, etc. can be used as the transition metal. Some examples include lithium-containing composite metal oxides such as LiCoO₂, LiNiO₂, LiMnO₂, LiMn₂O₄, LiFePO₄ and LiFeVO₄; transition metal sulfides such as TiS₂, TiS₃ and amorphous MoS₂; transition metal oxides such as Cu₂V₂O₃, or amorphous V₂O—P₂O₅, MoO₃, V₂O₅ and V₆O₁₃. In some aspects, the positive electrode material comprises a lithium nickel manganese cobalt oxide (hereinafter referred to as NMC, Li-NMC, LNMC, or NCM), which are mixed metal oxides of lithium, nickel, manganese and cobalt with the general formula LiNiₓMn_{y}Co_{1-x-y}O₂. In some aspects, the positive electrode material comprises at least one of LiCoO₂, LiMn₂O₄, LiMnO₂, or LiNiO₂. In some aspects, the positive electrode material comprises sulfur.

In addition, an additional material may be used depending on what a lithium secondary battery is used for. For example, a transition-metal-compound-based active material or a sulfide-based active material may be used.

Any suitable solid electrolyte material may be used. In some aspects, a sulfide-containing electrolyte material may be used for the solid electrolyte-electrode assembly. As used here, “sulfide-based electrolyte” refers to an electrolyte that includes inorganic materials containing S which conduct ions (e.g., Li⁺), and which are suitable for electrically insulating the positive and negative electrodes of an electrochemical cell. Exemplary sulfide-containing electrolytes are set forth in Shaojie Chen et al., “Sulfide solid electrolytes for all-solid-state lithium batteries: Structure, conductivity, stability and application,” Energy Storage Materials, Volume 14, Pages 58-74 (September 2018), which is hereby expressly incorporated by reference in its entirety.

For example, many sulfide-containing electrolyte materials are particularly attractive due to their superionic conductivities (as high as ˜10-2 S cm−1) and deformability. In particular, Li₃P₇S₁₁, Li₁₀GeP₂Si₂, and Na₃PS₄ and Li₆PS₅Cl have been reported to exhibit high ionic conductivities; some even close to those of liquid electrolytes. According to aspects of the disclosure, the sulfide solid electrolyte materials also provide a low Young's modulus, which is beneficial for producing favorable interface contacts with electrode materials by simple cold pressing at room temperature.

The sulfide-containing solid electrolyte, according to aspects of the disclosure, may contain sulfur (S) and have the ionic conductivity of metal belonging to Group I or II in the periodic table, e.g., Li⁺. Additionally, in an aspect of the present disclosure, the selected solid electrolyte has the ionic conductivity of 1×10⁻⁵ S/cm, or according to some aspects of the disclosure, 1×10⁻³ S/cm or more.

Non-limiting examples of the sulfide-containing solid electrolyte may include Li—P—S-based glass, Li—P—S-based glass ceramic and argyrodite-based sulfide-containing solid electrolyte.

Non-limiting examples of the sulfide-containing solid electrolyte may include at least one of xLi₂S-yP₂S₅, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂ or Li₂S—GeS₂—ZnS, Li₆PS₅X (X=at least one of Cl, Br or I).

In an aspect of the present disclosure, the sulfide-containing solid electrolyte may comprise at least one selected from LPS-based glass or glass ceramic such as xLi₂S-yP₂S₅, or an argyrodite-based sulfide-containing solid electrolyte (Li₆PS₅X; X═Cl, Br, I).

In another aspect, the solid electrolyte may include a solid electrolyte commonly used in the all-solid-state battery, such as an inorganic solid electrolyte or an organic solid electrolyte may be used.

In the case of the inorganic solid electrolyte, a ceramic material, a crystalline material or an amorphous material may be used. For instance, inorganic solid electrolytes such as thio-LISICON (Li_{3.25}Ge_{0.25}P_{0.25}S₄), L₂S—SiS₂, LiI—Li₂S—SiS₂, LiI—Li₂S—P₂S₅, LiI—Li₂S—P₂O₅, LiI—Li₃PO₄—P₂S₅, Li₂S—P₂S₅, Li₃PS₄, Li₂P₃S₁₁, Li₂O—B₂O₃, Li₂O—B₂O₃—P₂O₅, Li₂O—V₂O₅—SiO₂, Li₂O—B₂O₃, Li₃PO₄, Li₂O—Li₂WO₄—B₂O₃, UPON, LiBON, Li₂O—SiO₂, LiI, Li₃N, Li₅La₃Ta₂O₁₂, Li₇La₃Zr₂O₁₂, Li₆BaLa₂Ta₂O₁₂, Li₃PO_{(4-3/2w)}Nw (wherein w is w<1), and Li_{3.6}Si_{0.6}P_{0.4}O₄ can be used.

The average size of sulfide-based particles is, for example, 0.1 μm to 50 μm, preferably 0.5 μm to 20 μm, which is within the size range of sulfide-based particles used in well-known all-solid-state batteries. In the case in which the average size of the sulfide-based particles is less than the above range, the sulfide-based particles may form lumps. In the case in which the average size of the sulfide-based particles is greater than the above range, on the other hand, the porosity of the manufactured solid electrolyte is high, whereby the characteristics of the battery may be deteriorated. For example, the capacity of the battery may be reduced.

Preferably, the sulfide-based particle has an ion conductivity of 1×10⁻⁴ S/cm or more. More preferably, the sulfide-based particle has an ion conductivity of 1×10⁻³ S/cm or more.

In addition to the above-mentioned sulfide-based solid electrolytes, other well-known solid electrolytes may also be used. For example, an inorganic solid electrolyte, such as Li₂O—B₂O₃, Li₂O—B₂O₃—P₂O₅, Li₂O—V₂O₅—SiO₂, Li₃PO₄, Li₂O—Li₂WO₄—B₂O₃, LiPON, LiBON, Li₂O—SiO₂, LiI, Li₃N, Li₅La₃Ta₂O₁₂, Li₇La₃Zr₂O₁₂, Li₆BaLa₂Ta₂O₁₂, Li₃PO_{(4-3/2w)}N_{w} (w<1), or Li_{3.6}Si_{0.6}P_{0.4}O₄, may be used.

In addition, examples of the organic solid electrolyte include organic solid electrolytes prepared by mixing lithium salt to polymeric materials such as polyethylene derivatives, polyethylene oxide derivatives, polypropylene oxide derivatives, phosphate ester polymers, agitation lysine, polyester sulfide, polyvinyl alcohol, aid polyvinylidene fluoride. In this case, these may be used alone or in combination of at least one.

The above-described coated sulfide-containing electrolyte material can be used for a solid electrolyte for an all-solid-state battery. The all-solid-state battery contains a positive electrode, a negative electrode, with the solid electrolyte interposed therebetween.

Meanwhile, the positive electrode and the negative electrode for the all-solid-state battery according to aspects of the present disclosure are not particularly limited and any suitable one known in the art can be used.

The all-solid-state battery proposed according to aspects of the present disclosure defines the constitution of the solid electrolyte as described above, and the other elements constituting the battery, that is, the positive electrode and the negative electrode, are not particularly limited in the present disclosure and follow the description below.

In an aspect, the negative electrode for the all-solid-state battery is a lithium metal alone, or negative electrode active material can be laminated on the negative electrode current collector.

### <Manufacturing>

In certain aspects, the all-solid-state battery is manufactured through a dry process, in which electrode powder (e.g., plurality of cathode particles), a solid electrolyte powder (e.g., wherein the solid electrolyte is provided in the form of particles or powders having an average particle size less than 5 m), and a binder are provided, and the solid electrolyte-cathode assembly is formed by a co-rolling process. In aspects, the solid electrolyte particles may optionally be ball-milled to reduce the particle size, which expands the contact area between cathode materials and the solid electrolyte, resulting in higher Li transport characteristics.

The co-rolling process can be carried out using a rotating tray method, a rotating cylindrical method, or a rotating cone method. The co-rolling process may be a continuous roll-to-roll process.

In addition, if necessary, a rolling process, in which the electrode is passed through a gap between two heated rolls such that the electrode is compressed so as to have a desired thickness, may be performed in order to increase the capacity density of the electrode and to improve adhesion between the current collector and the active material after the drying process. In the present disclosure, the rolling process is not particularly restricted. A well-known rolling process, such as pressing, may be performed. For example, the electrode may pass through a gap between rotating rolls, or a flat press machine may be used to press the electrode.

### Examples

The following examples are not intended to be limiting. The above disclosure provides many different aspects for implementing the features of the disclosure, and the following examples describe certain aspects. It will be appreciated that other modifications and methods known to one of ordinary skill in the art can also be applied to the following experimental procedures, without departing from the scope of the disclosure.

### Experimental Examples

A co-rolled film according to disclosed aspects was prepared as follows. For a cathode layer, polycrystalline LiNi_{0.8}Co_{0.1}Mn_{0.1}O₂(PC-NCM, NCM811, LG Chem) or single crystalline LiNi_{0.82}Co_{0.11}Mn_{0.07}O₂(SC-NCM, NCM82, MSE Supplies), Li₆PS₅Cl (LPSCl, Mitsui), and vapor-grown carbon fiber (VGCF, Sigma-Aldrich) (80:17:3 by weight) were mixed in a mortar and pestle for 30 min. The powder mixture and polytetrafluoroethylene (PTFE, Chemours) (100:0.5 by weight) were transferred into a 20 mL vial and vortex mixed at 3000 rpm for 3 min. The mixture was shear mixed in a mortar and pestle until dough was formed. The dough was roll-pressed using roll-press machine (TMAXCN) at 120° C. with a fixed roller gap of 2 mm by folding and rotating, which was repeated 30 times to fibrillate PTFE binder. For an SSE layer, LPSCl (NEI Corporation) was ball-milled at 400 rpm for 2 h using planetary ball miller (TMAXCN) in a zirconia jar with zirconia balls sealed in an argon-filled atmosphere to reduce particle size. Ball-milling was conducted twice to homogenize particle size. With ball-milled LPSCl and PTFE (100:0.1 by weight), the SSE layer was obtained using the same procedure as the cathode layer.

For the co-rolled film, cathode and SSE, feed layers were controlled to a weight ratio of approximately 3.5.1. The initial thickness of SSE feed layer was fixed to 600 μm. After cutting feed layers into a 2.54 cm×2.54 cm (1 in×1 in) dimension using a cutter, the feed layers were stacked and roll-pressed with a desired reduction temperature (120° C. or 30° C.) and reduction thickness (20 μm or 100 μm) until desired cathode loading was achieved. The cathode loading of co-rolled film was calculated and controlled based on the weight ratio of SSE feed to cathode feed.

In the experiments below, Examples according to disclosed aspects were formed as described above.

### Experiment I

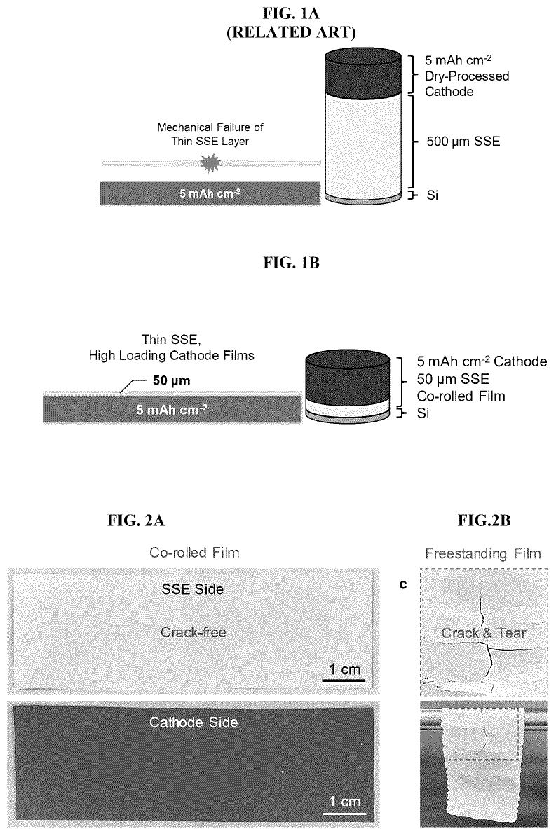

FIG. 1A shows Comparative Example 1 formed conventionally and FIG. 1B shows Example 1 formed according to disclosed aspects where the SSE assembly is formed by co-rolling a plurality of cathode particles and a plurality of solid electrolyte particles, as discussed above. As seen in FIG. 1A, in Comparative Example 1, there is a problem of mechanical failure when using a thin SSE to form an assembly, which is due to poor mechanical property of the film. As seen in FIG. 1B, in Example 1, there is simultaneous production of the assembly, which mitigates mechanical failure of the thin SSE layer.

### Experiment II

FIG. 2A shows Example 2 formed according to disclosed aspects where the solid electrolyte-electrode assembly is formed by co-rolling a plurality of cathode particles and a plurality of solid electrolyte particles, as discussed above, and Comparative Example 2 (freestanding) formed without co-rolling. As seen in FIG. 2B, in Comparative Example 2, there is a problem of cracking when using a freestanding SSE film to form an assembly, which is due to poor mechanical property of the film. As seen in FIG. 2A, in Example 2, there is no cracking of the thin SSE layer.

### Experiment III

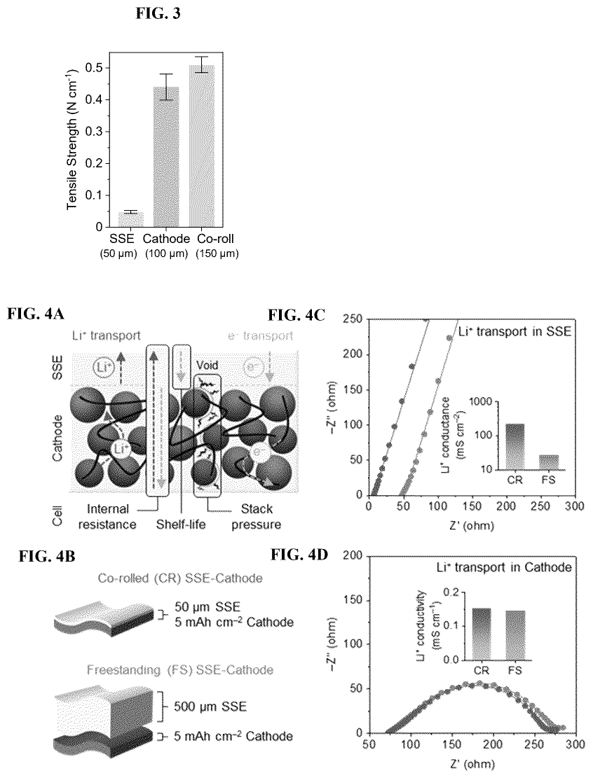

FIG. 3 shows Example 3 (co-roll) formed according to disclosed aspects where the solid electrolyte-electrode assembly is formed by co-rolling a plurality of cathode particles and a plurality of solid electrolyte particles, as discussed above, and Comparative Example 3 (SSE) and Comparative Example 4 (cathode) formed without co-rolling. As seen in FIG. 3, Example 3 exhibited higher tensile strength than either Comparative Example 3 (SSE) or Comparative Example 4 (cathode).

### Experiment IV

FIGS. 4A and 4B show Example 4 formed according to disclosed aspects where the solid electrolyte-electrode assembly is formed by co-rolling a plurality of cathode particles and a plurality of solid electrolyte particles, as discussed above, and Comparative Example 5 (freestanding) formed without co-rolling. FIGS. 4C and 4D illustrate the electrochemical characterizations of Example 4 and Comparative Example 5. As seen in FIG. 4C, Example 4 exhibited a superior lithium ion transport profile in the solid electrolyte compared to Comparative Example 5. As seen in FIG. 4D, Example 4 exhibited a superior lithium ion transport profile in the cathode compared to Comparative Example 5.

It will be understood by those of ordinary skill in the art that aspects of the present disclosure can be performed within a wide equivalent range of parameters without affecting the scope of the disclosure described herein. All publications, patent applications and patents disclosed herein are incorporated by reference in their entirety.

1. A method for manufacturing a solid electrolyte-cathode assembly, comprising:
providing a plurality of cathode particles;
providing a solid electrolyte, wherein the solid electrolyte is provided in the form of particles having an average particle size less than 5 μm;
providing a binder; and
co-rolling the plurality of cathode particles, the solid electrolyte, and the binder, under conditions to form the solid electrolyte-cathode assembly,
wherein the solid electrolyte-cathode assembly comprises a cathode layer having a thickness less than 50 μm and a solid electrolyte layer having a thickness less than 50 μm, such that the cathode layer structurally supports the solid electrolyte layer;
wherein an amount of the binder is less than 1% wt., such that contact between the cathode layer and the solid electrolyte layer is increased; and
wherein a ratio of a thickness of the cathode layer to a thickness of the solid electrolyte layer is from 1:1 to 1:5 such that an interface resistance between the cathode layer and the solid electrolyte layer is reduced.

2. The method according to claim 1, wherein the amount of binder is less than 0.5% wt.

3. The method according to claim 1, wherein the amount of binder is less than 0.1% wt.

4. The method according to claim 1, wherein the cathode layer has a thickness of greater than or equal to 25 μm.

5. The method according to claim 1, wherein the cathode layer has a thickness of greater than or equal to 15 μm.

6. The method according to claim 1, wherein the solid electrolyte layer has a thickness less than 40 μm.

7. (canceled)

8. The method according to claim 1, wherein a weight ratio of the plurality of cathode particles to the solid electrolyte is from 1:1 to 1:5.

9. The method according to claim 1, wherein a ratio of a thickness of the cathode layer to a thickness of the solid electrolyte layer is from 1:2 to 1:4.

10. The method according to claim 1, wherein the method is carried out under dry processing conditions.

11. The method according to claim 1, wherein the co-rolling of the cathode particles is carried out at a temperature of from about room temperature to about 120° C.

12. The method according to claim 1, wherein the cathode particles have an average particle size of 0.1 μm to 20 μm.

13. A method for manufacturing a solid electrolyte-cathode assembly, comprising:
providing a plurality of cathode particles, wherein the cathode particles comprise a lithium nickel manganese cobalt oxide;
providing a solid electrolyte, wherein the solid electrolyte is provided in the form of particles having an average particle size less than 5 μm;
providing a binder; and
co-rolling the plurality of cathode particles, the solid electrolyte, and the binder, under conditions to form the solid electrolyte-cathode assembly,
wherein the solid electrolyte-cathode assembly comprises a cathode layer having a thickness of more than 10 μm and less than 50 μm and a solid electrolyte layer having a thickness of more than 10 μm and less than 50 μm, such that the cathode layer structurally supports the solid electrolyte layer;
wherein an amount of the binder is less than 1%, such that contact between the cathode layer and the solid electrolyte layer is increased; and
wherein a ratio of a thickness of the cathode layer to a thickness of the solid electrolyte layer is from 1:1 to 1:5 such that an interface resistance between the cathode layer and the solid electrolyte layer is reduced.

14. The method according to claim 13, wherein a weight ratio of the plurality of cathode particles to the solid electrolyte is from 1:1 to 1:5.

15. The method according to claim 13, wherein a ratio of a thickness of the cathode layer to a thickness of the solid electrolyte layer is from 1:1 to 1:10.

16. A solid electrolyte-cathode assembly, prepared by:
providing a plurality of cathode particles;
providing a solid electrolyte, wherein the solid electrolyte is provided in the form of particles having an average particle size less than 5 μm;
providing a binder; and
co-rolling the plurality of cathode particles, the solid electrolyte, and the binder, under conditions to form the solid electrolyte-cathode assembly,
wherein the solid electrolyte-cathode assembly comprises a cathode layer having a thickness of more than 10 μm and less than 50 μm and a solid electrolyte layer having a thickness of more than 10 μm and less than 50 μm, such that the cathode layer structurally supports the solid electrolyte layer;
wherein the solid electrolyte-cathode assembly does not have a current collector;
wherein an amount of the binder is less than 1%, such that contact between the cathode layer and the solid electrolyte layer is increased; and
wherein a ratio of a thickness of the cathode layer to a thickness of the solid electrolyte layer is from 1:1 to 1:5 such that an interface resistance between the cathode layer and the solid electrolyte layer is increased.

17. The solid electrolyte-cathode assembly according to claim 16, wherein a weight ratio of the cathode particles to the solid electrolyte is from 1:1 to 1:5.

18. The solid electrolyte-cathode assembly according to claim 16, wherein a ratio of a thickness of the cathode layer to a thickness of the solid electrolyte layer is from 1:1 to 1:5.

19. The solid electrolyte-cathode assembly according to claim 16, having a porosity greater than about 3%.

20. An all-solid-state battery comprising the solid electrolyte-cathode assembly according to claim 16.

21. An electric vehicle comprising the all-solid-state battery according to claim 20.
